(19) United States
(12) Patent Application Publication
(10) Pub. No.: US 2026/0323190 A1
(43) Pub. Date: Oct. 15, 2026

(54) LIGHT DETECTION DEVICE

(71) Applicant: Sony Semiconductor Solutions Corporation, Kanagawa (JP)

(72) Inventors: Yuki Ozawa, Kanagawa (JP); Toshikazu Oda, Kanagawa (JP)

(21) Appl. No.: 19/485,074

(22) PCT Filed: May 7, 2024
(86) PCT No.: PCT/JP2024/017001

§ 371 Date: Nov. 17, 2025

(30) Foreign Application Priority Data
Jun. 26, 2023 (JP) 2023-103870

(51) Int. Cl. H04N 25/78

(52) U.S. Cl. CPC H04N 25/78

(57) ABSTRACT

In light detection devices, current of a load transistor in a non-readout period is reduced while the degradation of an image quality is suppressed. In one example, a light detection device includes a first signal line connected to a first effective pixel; a first current source connected to the first signal line; a first switch between the first effective pixel and the first current source; a second signal line connected to a second effective pixel; a second current source connected to the second signal line; a second switch between the second effective pixel and the second current source; and a horizontal connection signal line that connects the first signal line and the second signal line. A control unit controls a potential of the horizontal connection signal line on the basis of a potential of a dummy signal line.

### TECHNICAL FIELD

The present technology relates to a light detection device. Specifically, the present technology relates to a light detection device capable of forming a source floor between a pixel and a load transistor via a vertical signal line.

### BACKGROUND ART

In order to achieve low power consumption of an imaging device, there is a method of separating a vertical signal line and a load transistor in a non-readout period. For example, a solid-state imaging device has been proposed in which, after a comparator of an A/D converter is inverted, the supply of the current is stopped in a load MOS circuit to achieve reduction in power consumption (see, for example, Patent Document 1).

### CITATION LIST

### Patent Document

Patent Document 1: Japanese Patent Laid-open Publication No. 2020-88785

### SUMMARY OF THE INVENTION

### Problems to be Solved by the Invention

However, when the current of a load transistor is stopped in a non-readout period, the potential of a vertical signal line in the non-readout period is separated from the potential of the vertical signal line in a readout period, and there is a possibility that the image quality is degraded due to capacitive coupling.

The present technology has been made in view of such a situation, and an object thereof is to reduce the current of the load transistor in the non-readout period while suppressing the degradation of the image quality.

### Solutions to Problems

The present technology has been made to solve the above-described problems, and a first aspect thereof is a light detection device including: a first signal line connected to a first effective pixel; a first current source connected to the first signal line; a first switch provided between the first effective pixel and the first current source; a second signal line connected to a second effective pixel; a second current source connected to the second signal line; a second switch provided between the second effective pixel and the second current source; a horizontal connection signal line that connects the first signal line and the second signal line; a dummy signal line connected to a dummy pixel; a third current source connected to the dummy signal line; and a control unit that controls a potential of the horizontal connection signal line on the basis of a potential of the dummy signal line. This brings about an effect of suppressing the divergence between the potential of the vertical signal line in a non-readout period and the potential of the vertical signal line in a readout period while stopping a current of a load transistor in the non-readout period.

In addition, in the first aspect, the control unit may perform control such that the dummy signal line and the horizontal connection signal line have the same potential. This brings about an effect of matching the potential of the vertical signal line in the non-readout period and the potential of the vertical signal line in the readout period while stopping the current of the load transistor in the non-readout period.

Furthermore, in the first aspect, the control unit may include an operational amplifier in which a first input is connected to the dummy signal line and a second input is connected to the horizontal connection signal line. This brings about an effect of comparing the potential of the dummy signal line with the potential of the horizontal connection signal line.

In addition, in the first aspect, the control unit may include a transistor that drives the horizontal connection signal line on the basis of an output of the operational amplifier. This brings about an effect of controlling the potential of the horizontal connection signal line on the basis of the comparison result between the potential of the dummy signal line and the potential of the horizontal connection signal line.

Furthermore, in the first aspect, the control unit may include a mode setting unit that sets a current flowing through the transistor in a readout period. This brings about an effect of controlling the current flowing through the transistor in the readout period.

In addition, in the first aspect, the dummy pixel may include an optical black (OPB) pixel. This brings about an effect of matching the potential of the vertical signal line in the non-readout period and the potential of the vertical signal line in the readout period while coping with manufacturing variations in characteristics of the light detection device.

Furthermore, in the first aspect, the light detection device may further include: a third switch provided between the first signal line and the horizontal connection signal line; and a fourth switch provided between the second signal line and the horizontal connection signal line. This brings about an effect of making it possible to disconnect the first and second signal lines from the horizontal connection signal lines in the readout period.

In addition, in the first aspect, the first switch and the second switch may be turned off in a vertical blanking period, and the third switch and the fourth switch may be turned on in the vertical blanking period. This brings about an effect of matching the potential of the vertical signal line in the vertical blanking period and the potential of the vertical signal line in the readout period while stopping the current of the load transistor in the vertical blanking period.

Furthermore, in the first aspect, the first switch and the second switch may be turned off in a horizontal blanking period, and the third switch and the fourth switch may be turned on in the horizontal blanking period. This brings about an effect of matching the potential of the vertical signal line in the horizontal blanking period and the potential of the vertical signal line in the readout period while stopping the current of the load transistor in the horizontal blanking period.

In addition, in the first aspect, the light detection device may further include a fifth switch provided between the dummy pixel and the third current source. This brings about an effect of disconnecting the dummy pixel and the third current source in the readout period.

Furthermore, in the first aspect, the fifth switch may be turned on in the vertical blanking period and turned off in the readout period. This brings about an effect of flowing the current in the dummy signal line in the vertical blanking period and stopping the current flowing in the dummy signal line in the readout period.

In addition, in the first aspect, the fifth switch may be turned on in the horizontal blanking period and turned off in the readout period. This brings about an effect of flowing the current in the dummy signal line in the horizontal blanking period and stopping the current flowing in the dummy signal line in the readout period.

Furthermore, in the first aspect, the light detection device may further include: a first column in which the first effective pixels are arranged in a column direction; a second column in which the second effective pixels are arranged in the column direction; and a dummy column in which the dummy pixels are arranged in the column direction. This brings about an effect of, in a pixel array unit in which the effective pixels are arranged in a matrix in the row direction and the column direction, suppressing the divergence between the potential of the vertical signal line in a non-readout period and the potential of the vertical signal line in a readout period while stopping a current of a load transistor in the non-readout period.

In addition, in the first aspect, the first column may include the first effective pixel and a first OPB pixel, the second column may include the second effective pixel and a second OPB pixel, and the dummy column may include a dummy effective pixel and a dummy OPB pixel.

This brings about an effect of, in a pixel array unit in which the effective pixels are arranged in a matrix in the row direction and the column direction, matching the potential of the vertical signal line in the non-readout period and the potential of the vertical signal line in the readout period while coping with manufacturing variations in characteristics of the light detection device.

Furthermore, in the first aspect, a plurality of the dummy columns may be provided. This brings about an effect of improving the output accuracy of the dummy column.

### BRIEF DESCRIPTION OF DRAWINGS

FIG. 1 is a block diagram illustrating a configuration example of an imaging device according to a first embodiment.

FIG. 2 is a block diagram illustrating a configuration example of a solid-state imaging device according to the first embodiment.

FIG. 3 is a diagram illustrating a circuit configuration example of a pixel provided in the solid-state imaging device according to the first embodiment.

FIG. 4 is a diagram illustrating a configuration example of a column readout circuit provided in the solid-state imaging device according to the first embodiment.

FIG. 5 is a timing chart illustrating an example of a readout period and a non-readout period of the solid-state imaging device according to the first embodiment.

FIG. 6 is a timing chart illustrating an example of a waveform of a vertical signal line in a horizontal blanking period and an AD conversion period of the solid-state imaging device according to the first embodiment.

FIG. 7 is a diagram illustrating a relationship between a load current and a control current in each mode of the solid-state imaging device according to the first embodiment.

FIG. 8 is a diagram illustrating a relationship between a frame rate and current consumption in each mode of the solid-state imaging device according to the first embodiment.

FIG. 9 is a diagram illustrating a configuration example of a column readout circuit provided in a solid-state imaging device according to a second embodiment.

FIG. 10 is a block diagram illustrating a configuration example of a solid-state imaging device according to a third embodiment.

FIG. 11 is a diagram illustrating a circuit configuration example of a pixel provided in a solid-state imaging device according to a fourth embodiment.

FIG. 12 is a perspective view illustrating a lamination example of a solid-state imaging device according to a fifth embodiment.

### MODE FOR CARRYING OUT THE INVENTION

Modes for carrying out the present technology (hereinafter, referred to as embodiments) will be described below. The description will be given in the following order.

1. First embodiment (an example of controlling the potential of a horizontal connection signal line connecting a vertical signal line to which an effective pixel is connected on the basis of the potential of a dummy signal line connected to a dummy pixel provided in a dummy column)
2. Second embodiment (an example of providing a plurality of dummy columns in which dummy pixels connected to dummy signal lines are arranged in a column direction)
3. Third embodiment (an example of providing n (n is a positive integer less than m) columns of dummy columns in a part of m (m is a positive integer) columns of ineffective pixel columns provided around an effective pixel array)
4. Fourth embodiment (an example of using a Hall sensor for a pixel)
5. Fifth embodiment (an example of laminating semiconductor chips on which a solid-state imaging device is formed)

### 1. First Embodiment

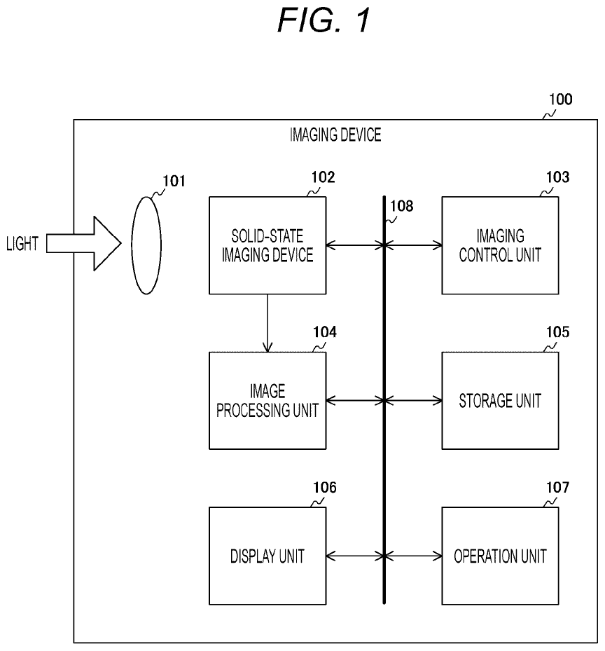

FIG. 1 is a diagram illustrating a configuration example of an imaging device including a light detection device according to a first embodiment. Note that, in the following description, a solid-state imaging device is taken as an example of the light detection device.

In the drawing, an imaging device 100 includes an optical system 101, a solid-state imaging device 102, an imaging control unit 103, an image processing unit 104, a storage unit 105, a display unit 106, and an operation unit 107. The imaging control unit 103, the image processing unit 104, the storage unit 105, the display unit 106, and the operation unit 107 are interconnected via a bus 108. Note that the imaging device 100 may be used alone, may be incorporated in a mobile terminal such as a smartphone, may be incorporated in an authentication device or a monitoring device, or may be incorporated in a vehicle or a drone.

The optical system 101 causes light from a subject to enter the solid-state imaging device 102, and forms an optical image on a light-receiving surface of the solid-state imaging device 102. The optical system 101 can include, for example, a focus lens, a zoom lens, a diaphragm, and the like. The optical system 101 may include a plurality of lenses such as a wide-angle lens, a standard lens, and a telephoto lens.

The solid-state imaging device 102 converts the optical image formed on the light-receiving surface into an electric signal for each pixel, and digitizes and outputs the electric signal. The solid-state imaging device 102 is, for example, a complementary metal oxide semiconductor (CMOS) image sensor. The CMOS image sensor may be a back-irradiation image sensor or a front-irradiation image sensor. Note that the light detection device is not limited to the solid-state imaging device 102, and may be applied to a time of flight (ToF) sensor, an event-based vision sensor, or the like.

The imaging control unit 103 controls the imaging by the solid-state imaging device 102 on the basis of a command from the operation unit 107. At this time, the imaging control unit 103 can control the exposure time, the exposure amount, the imaging timing, and the like of the solid-state imaging device 102.

The image processing unit 104 performs image processing on the basis of the output from the solid-state imaging device 102. The image processing is, for example, gamma correction, white balance processing, sharpness processing, or gradation conversion processing. The image processing unit 104 may include a processor that executes processing on the basis of software.

The storage unit 105 stores a captured image captured by the solid-state imaging device 102, and stores imaging parameters and the like of the solid-state imaging device 102. In addition, the storage unit 105 can store a program for causing the imaging device 100 to operate on the basis of software. The storage unit 105 may include a read only memory (ROM), a random access memory (RAM), and a memory card.

The display unit 106 displays the captured image and displays various types of information supporting the imaging operation. The display unit 106 may be a liquid crystal display or an organic electro luminescence (EL) display.

The operation unit 107 provides a user interface for operating the imaging device 100. The operation unit 107 may include, for example, a button, a dial, and a switch provided in the imaging device 100. The operation unit 107 may be implemented as a touch panel together with the display unit 106.

Note that, depending on the form of the imaging device 100, some of the above-described functions may be omitted, or conversely, functions that are not disclosed may be further included.

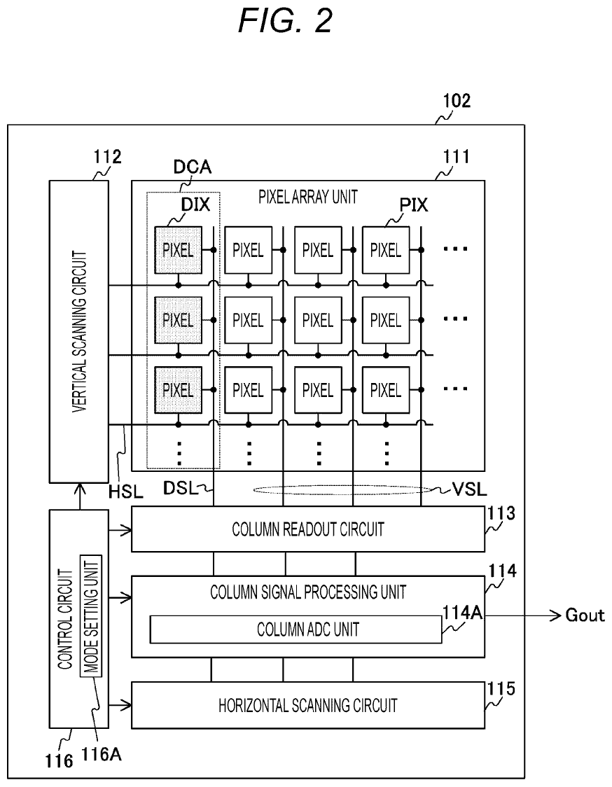

FIG. 2 is a block diagram illustrating a configuration example of the solid-state imaging device according to the first embodiment.

In FIG. 2, the solid-state imaging device 102 includes a pixel array unit 111, a vertical scanning circuit 112, a column readout circuit 113, a column signal processing unit 114, a horizontal scanning circuit 115, and a control circuit 116.

The pixel array unit 111 includes dummy pixels DIX and a plurality of pixels PIX. At this time, the pixel array unit 111 can be provided with a dummy column DCA in which the dummy pixels DIX are arranged in the column direction. The pixels PIX are arranged in a matrix along a row direction (also referred to as a horizontal direction) and the column direction (also referred to as a vertical direction). Each of the dummy pixels DIX and each of the pixels PIX can include an effective pixel capable of receiving incident light and a shielded OPB pixel. Each dummy pixel DIX and each pixel PIX may have sensitivity to visible light, may have sensitivity to near infrared light (NIR), may have sensitivity to short wavelength infrared light (SWIR), or may have sensitivity to ultraviolet light, X-rays, or the like. Note that, in a case where each pixel PIX has sensitivity to visible light, each pixel PIX may form a Bayer array or may form a quad-Bayer array. In a case where each dummy pixel DIX and each pixel PIX have sensitivity to infrared light, each dummy pixel DIX and each pixel PIX may be formed by a Hall sensor in order to improve conversion efficiency. In the Hall sensor, holes can be generated more efficiently than electrons during photoelectric conversion.

Each dummy pixel DIX and each pixel PIX can form a source follower with the column readout circuit 113 at the time of signal readout. The dummy pixel DIX and each pixel PIX are connected to a horizontal drive line HSL for each row. In addition, the dummy pixel DIX is connected to a dummy signal line DSL for each column, and the pixel PIX is connected to a vertical signal line VSL for each column. The horizontal drive line HSL drives each dummy pixel DIX and each pixel PIX for each row at the time of reading out the signal from each dummy pixel DIX and each pixel PIX. The vertical signal line VSL transmits the signal read out from the pixel PIX to the column signal processing unit 114 for each column. The dummy signal line DSL connects each dummy pixel DIX to a current source.

The vertical scanning circuit 112 scans the pixels PIX to be read out in the column direction. The vertical scanning circuit 112 may include a vertical register. Here, the vertical scanning circuit 112 can drive each pixel PIX for each row via the horizontal drive line HSL at the time of reading out the signal from each pixel PIX.

The column readout circuit 113 can form a source follower with each pixel PIX at the time of reading out a signal from each pixel PIX. At this time, the column readout circuit 113 can change the potential of the vertical signal line VSL on the basis of the charge held in the pixel PIX.

In addition, the column readout circuit 113 can connect the vertical signal lines VSL of the respective columns to each other in the non-readout period. Then, the column readout circuit 113 can control the potential of the vertical signal lines VSL of the respective columns on the basis of the potential of the dummy signal line DSL. At this time, the column readout circuit 113 can perform control such that the dummy signal line DSL and the vertical signal line VSL of each column have the same potential. This control may be performed during a vertical blanking period or a horizontal blanking period.

The column signal processing unit 114 processes a signal transmitted from each pixel PIX in the column direction. For example, the column signal processing unit 114 can perform correlated double sampling (CDS) processing on the basis of the signal transmitted from each pixel PIX in the column direction. Furthermore, the column signal processing unit 114 can perform analog to digital (AD) conversion processing on the basis of the signal transmitted from each pixel PIX in the column direction and output an imaging signal Gout.

The column signal processing unit 114 includes a column ADC unit 114A. The column ADC unit 114A can perform the AD conversion processing in parallel for each column. At this time, the column ADC unit 114A can perform AD conversion for each column on the basis of a comparison result between a pixel signal read out from the pixel PIX and a reference signal. Note that the column readout circuit 113 and the column signal processing unit 114 may be provided on corresponding one of both sides of the pixel array unit 111 in the column direction.

The horizontal scanning circuit 115 scans the pixel PIX to be read out in the row direction. The horizontal scanning circuit 115 may include a horizontal register.

The control circuit 116 controls the vertical scanning circuit 112, the column readout circuit 113, the column signal processing unit 114, and the horizontal scanning circuit 115. For example, the control circuit 116 can control the scanning timing in the column direction, the scanning timing in the row direction, the operation timing of the column readout circuit 113, and the processing timing of the column signal processing unit 114.

In addition, the control circuit 116 can set a timing at which the potential of the vertical signal line VSL of each column is controlled on the basis of the potential of the dummy signal line DSL. The control circuit 116 may set this timing as a vertical blanking period or a horizontal blanking period.

The control circuit 116 includes a mode setting unit 116A. The mode setting unit 116A can set a mode for controlling the potential of the vertical signal line VSL of each column on the basis of the potential of the dummy signal line DSL. In this mode, the current consumption in the readout period can be switched. At this time, the mode setting unit 116A can set the normal mode, the low power consumption mode, and the standby mode. Note that the control circuit 116 is an example of a control unit described in the claims.

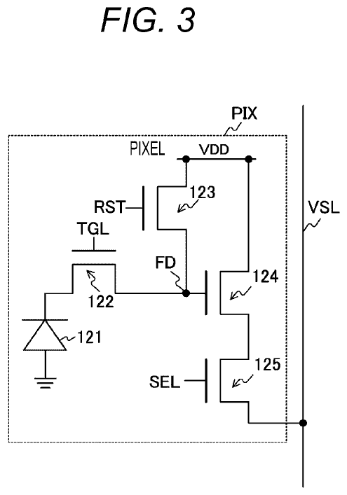

FIG. 3 is a block diagram illustrating a circuit configuration example of a pixel provided in the solid-state imaging device according to the first embodiment.

In FIG. 3, the pixel PIX includes a photodiode 121, a transfer transistor 122, a reset transistor 123, an amplification transistor 124, a selection transistor 125, and a floating diffusion FD. A metal oxide semiconductor (MOS) transistor can be used as the transfer transistor 122, the reset transistor 123, the amplification transistor 124, and the selection transistor 125.

The amplification transistor 124 and the selection transistor 125 are connected in series. A cathode of the photodiode 121 is connected to the floating diffusion FD via the transfer transistor 122. In addition, the floating diffusion FD is connected to a power supply VDD via the reset transistor 123. Furthermore, the power supply VDD is connected to the vertical signal line VSL via a series circuit of the amplification transistor 124 and the selection transistor 125. A gate of the amplification transistor 124 is connected to the floating diffusion FD.

A transfer signal TGL is applied to a gate of the transfer transistor 122. A reset signal RST is applied to a gate of the reset transistor 123. A selection signal SEL is applied to a gate of the selection transistor 125. The transfer signal TGL, the reset signal RST, and the selection signal SEL can be transmitted to each pixel PIX via the horizontal drive line HSL in FIG. 2.

When the transfer transistor 122 is turned on, the charge accumulated in the photodiode 121 is transferred to the floating diffusion FD. Then, when the selection transistor 125 is turned on, the source potential of the amplification transistor 124 changes according to the potential of the floating diffusion FD. Then, the source potential of the amplification transistor 124 is applied to the vertical signal line VSL via the selection transistor 125 and transmitted via the vertical signal line VSL. In addition, when the reset transistor 123 is turned on, the charge accumulated in the floating diffusion FD is discharged.

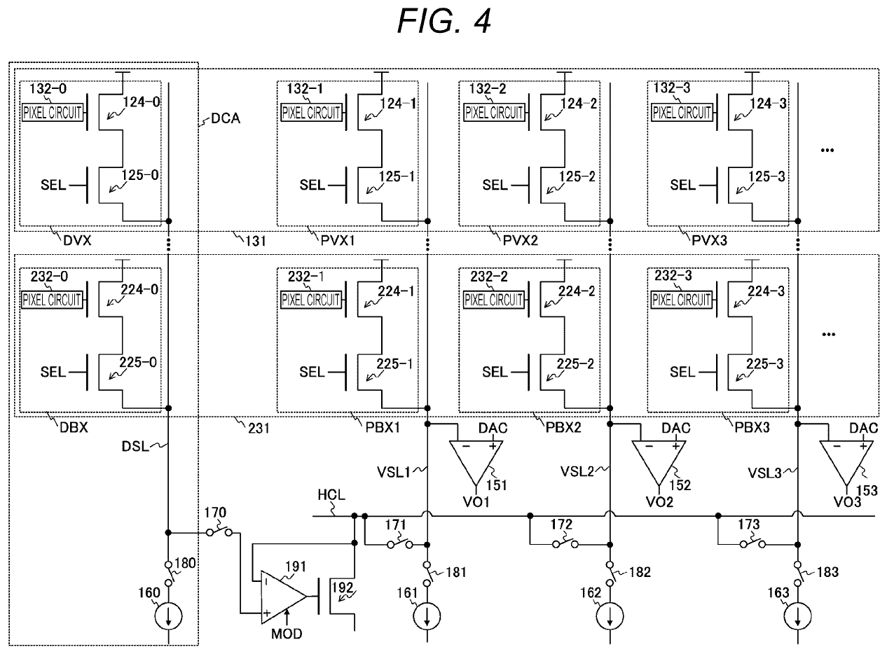

FIG. 4 is a diagram illustrating a configuration example of the column readout circuit provided in the solid-state imaging device according to the first embodiment.

In FIG. 4, the pixel array unit 111 is provided with an effective pixel region 131 and an OPB pixel region 231. In the effective pixel region 131, a dummy effective pixel DVX and effective pixels PVX1 to PVX3 . . . are arranged. In the OPB pixel region 231, a dummy OPB pixel DBX and OPB pixels PBX1 to PBX3 . . . are arranged. The dummy effective pixel DVX and the dummy OPB pixel DBX are arranged in the dummy column DCA.

The dummy effective pixel DVX includes a pixel circuit 132-0, an amplification transistor 124-0, and a selection transistor 125-0. The dummy OPB pixel DBX includes a pixel circuit 232-0, an amplification transistor 224-0, and a selection transistor 225-0. The effective pixels PVX1 to PVX3 . . . include pixel circuits 132-1 to 132-3 . . . , amplification transistors 124-1 to 124-3. and selection transistors 125-1 to 125-3 . . . , respectively. The OPB pixels PBX1 to PBX3 . . . include pixel circuits 232-1 to 232-3 . . . , amplification transistors 224-1 to 224-3 . . . , and selection transistors 225-1 to 225-3 . . . , respectively. Each of the pixel circuits 132-0 to 132-3 and 232-0 to 232-3 can include the photodiode 121, the transfer transistor 122, the reset transistor 123, and the floating diffusion FD.

The dummy effective pixel DVX and the dummy OPB pixel DBX are connected to the dummy signal line DSL. The effective pixels PVX1 to PVX3 . . . and the OPB pixels PBX1 to PBX3 . . . are connected to the vertical signal lines VSL1 to VSL3 . . . , respectively. The selection transistor 225-0 of the dummy OPB pixel DBX can be turned on/off independently of the selection transistor 125-0 of the dummy effective pixel DVX, the selection transistors 125-1 to 125-3 . . . of the effective pixels PVX1 to PVX3 . . . , respectively, and the selection transistors 225-1 to 225-3 . . . of the OPB pixels PBX1 to PBX3 . . . , respectively.

The dummy signal line DSL is connected to a current source 160 via a switch 180. In addition, the dummy signal line DSL is connected to an inverting input terminal of an operational amplifier 191 via a switch 170.

The vertical signal lines VSL1 to VSL3 . . . are connected to current sources 161 to 163 . . . via switches 181 to 183 . . . , respectively. In addition, the vertical signal lines VSL1 to VSL3 . . . are connected to a horizontal connection signal line HCL via switches 171 to 173 . . . , respectively. Each of the switches 170 to 173 . . . and 180 to 183 . . . may be a field effect transistor.

A non-inverting input terminal of the operational amplifier 191 and a drain of a drive transistor 192 are connected to the horizontal connection signal line HCL. The output of the operational amplifier 191 is connected to a gate of the drive transistor 192. At this time, the operational amplifier 191 compares the potential of the dummy signal line DSL with the potential of the horizontal connection signal line HCL, and can drive the drive transistor 192 such that the dummy signal line DSL and the horizontal connection signal line HCL have the same potential. The drive transistor 192 may be a field effect transistor.

Comparators 151 to 153 . . . are connected to the vertical signal lines VSL1 to VSL3, respectively. At this time, the potentials of the vertical signal lines VSL1 to VSL3 . . . are respectively applied to the inverting inputs of the comparators . . . 151 to 153. A reference signal DAC is input to the non-inverting input of each of the comparators 151 to 153. The reference signal DAC is, for example, a ramp signal. Then, the comparators 151 to 153 . . . , respectively compares the potentials of the vertical signal lines VSL1 to VSL3 with the reference signal DAC, and can output the comparison results VO1 to VO3, respectively.

The control circuit 116 can turn off the switches 181 to 183 . . . and turn on the switches 170 to 173 . . . and 180 in the vertical blanking period and the horizontal blanking period. In addition, the vertical scanning circuit 112 turns on the selection transistor 225-0 of the dummy OPB pixel DBX, and turns off the selection transistor 125-0 of the dummy effective pixel DVX, the selection transistors 125-1 to 125-3 . . . of the effective pixels PVX1 to PVX3 . . . , respectively, and the selection transistors 225-1 to 225-3 . . . of the OPB pixels PBX1 to PBX3 . . . , respectively. At this time, the column readout circuit 113 can perform control such that the dummy signal line DSL and the vertical signal line VSL of each column have the same potential.

In addition, the control circuit 116 can turn on the switches 181 to 183 . . . and turn off the switches 170 to 173 . . . and 180 in the readout period. Furthermore, the vertical scanning circuit 112 turns off the selection transistor 225-0 of the dummy OPB pixel DBX and the selection transistor 125-0 of the dummy effective pixel DVX, and turns on the selection transistors 125-1 to 125-3 . . . of the effective pixels PVX1 to PVX3. . . , respectively, and the selection transistors 225-1 to 225-3 . . . of the OPB pixels PBX1 to PBX3 . . . , respectively. At this time, the column ADC unit 114A can perform AD conversion on the pixel signals read out from the respective pixels PVX1 to PVX3 on the basis of the comparison results VO1 to VO3 output from the comparators 151 to 153 . . . , respectively.

In addition, the control circuit 116 can independently perform on/off control of the switch 180 and on/off control of the switches 181 to 183 . . . . For example, in a case where the switches 181 to 183 . . . are turned on, the control circuit 116 may turn on the switch 180 or may turn off the switch 180. Here, by turning off the switch 180 when the switches 181 to 183 . . . are turned on, it is possible to cut off the current flowing through the dummy signal line DSL in the readout period and achieve low power consumption.

In addition, the control circuit 116 inputs a mode setting signal MOD to the operational amplifier 191. The mode setting signal MOD can set the normal mode, the low power consumption mode, and the standby mode.

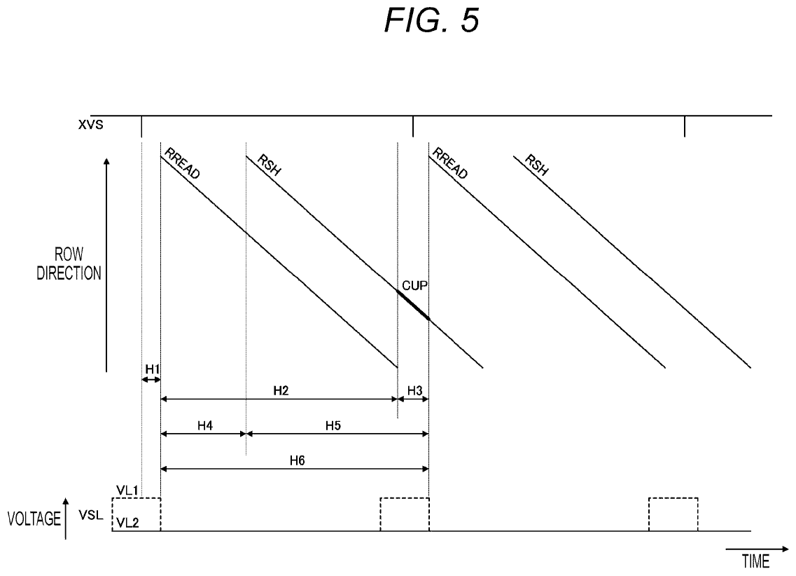

FIG. 5 is a timing chart illustrating an example of the readout period and the non-readout period of the solid-state imaging device according to the first embodiment.

In FIG. 5, a vertical period H6 for one frame is set according to a vertical synchronization signal XVS. A standby period H1 may be provided before the vertical period H6. In each vertical period H6, a vertical readout period H2 and a vertical blanking period H3 are set. In addition, in each vertical period H6, a non-exposure period H4 and an exposure period H5 are set.

When it is shifted to the vertical readout period H2, a readout operation PREAD from each pixel is performed for each row. When it is shifted to the exposure period H5, a shutter operation RSH of each pixel is performed for each row. Here, in the vertical blanking period H3, it is assumed that the switches 181 to 183 . . . are turned off, and the vertical signal lines VSL1 to VSL3 . . . are disconnected from the current sources 161 to 163 . . . , respectively. At this time, the potential VL1 of each of the vertical signal lines VSL1 to VSL3 . . . rises on the basis of the off-leak from the selection transistor 125, and a lateral streak occurs due to the coupling CUP between each of the vertical signal lines VSL1 to VSL3 . . . and the pixel.

Meanwhile, when the switches 181 to 183 . . . are turned off in the vertical blanking period H3, the switches 170 to 173 . . . and 180 are turned on. At this time, the vertical signal lines VSL1 to VSL3 . . . are connected to the horizontal connection signal line HCL via the switches 171 to 173 . . . , respectively. In addition, the dummy signal line DSL is connected to the current source 160. Then, the operational amplifier 191 drives the drive transistor 192 such that the dummy signal line DSL and the horizontal connection signal line HCL have the same potential. As a result, in the vertical blanking period H3, the rise of the potential VL2 of each of the vertical signal lines VSL1 to VSL3 . . . is suppressed, and the occurrence of the lateral streak caused by the coupling CUP between each of the vertical signal lines VSL1 to VSL3 . . . and the pixel is suppressed.

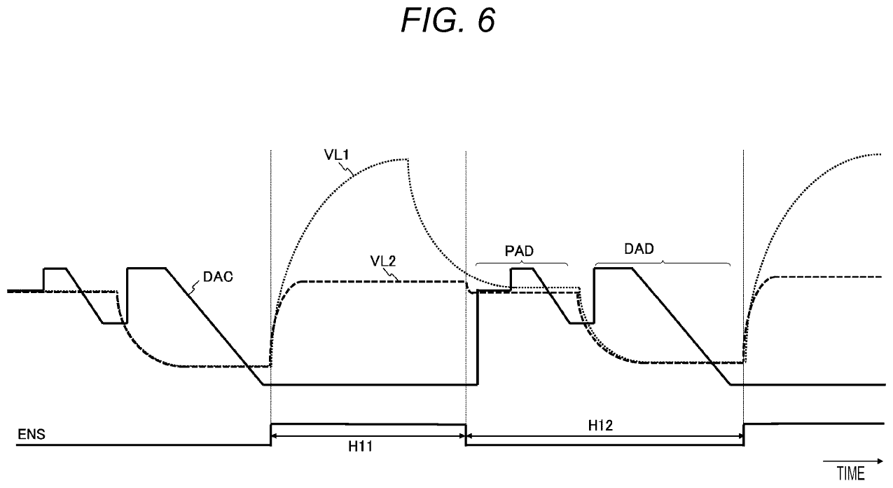

FIG. 6 is a timing chart illustrating an example of a waveform of the vertical signal line in the horizontal blanking period and an AD conversion period of the solid-state imaging device according to the first embodiment. Note that, in FIG. 6, the potentials VL1 and VL2 of the vertical signal lines are illustrated with their polarities inverted.

In FIG. 6, a horizontal blanking period H11 and a horizontal readout period H12 are set on the basis of a horizontal enable signal H11. In each horizontal readout period H12, a P-phase AD conversion period PAD and a D-phase AD conversion period DAD are provided.

Here, in the horizontal blanking period H11, it is assumed that the switches 181 to 183 . . . are turned off, and the vertical signal lines VSL1 to VSL3 . . . are disconnected from the current sources 161 to 163 . . . , respectively. At this time, the potential VL1 of each of the vertical signal lines VSL1 to VSL3 rises on the basis of the off-leak from the selection transistor 125.

Meanwhile, when the switches 181 to 183 . . . are turned off in the horizontal blanking period H11, the switches 170 to 173 . . . and 180 are turned on. At this time, the vertical signal lines VSL1 to VSL3 . . . are connected to the horizontal connection signal line HCL via the switches 171 to 173 . . . , respectively. In addition, the dummy signal line DSL is connected to the current source 160. Then, the operational amplifier 191 drives the drive transistor 192 such that the dummy signal line DSL and the horizontal connection signal line HCL have the same potential. As a result, in the horizontal blanking period H11, the rise of the potential VL2 of each of the vertical signal lines VSL1 to VSL3 . . . is suppressed. At this time, the potential VL2 of each of the vertical signal lines VSL1 to VSL3 can be set to an arbitrary level, and the settling time can be shortened. Therefore, the ratio (duty ratio) of the horizontal blanking period H11 in one horizontal period can be increased, and low power consumption in the horizontal blanking period H11 can be achieved.

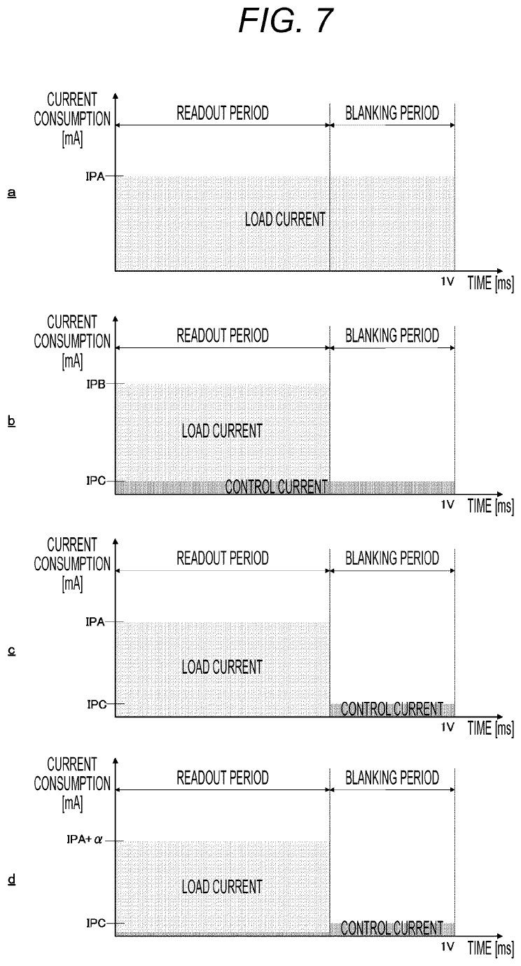

FIG. 7 is a diagram illustrating a relationship between a load current and a control current in each mode of the solid-state imaging device according to the first embodiment. Note that part a of FIG. 7 illustrates a current flowing through the vertical signal lines VSL1 to VSL3 . . . in the constant current mode (when the switches 181 to 183 . . . are turned on in the vertical blanking period). Part b of FIG. 7 illustrates a current flowing through the vertical signal lines VSL1 to VSL3 . . . in the normal mode when the switches 181 to 183 . . . are turned off in the vertical blanking period. Part c of FIG. 7 illustrates a current flowing through the vertical signal lines VSL1 to VSL3 . . . in the standby mode when the switches 181 to 183 . . . are turned off in the vertical blanking period. Part d of FIG. 7 illustrates a current flowing through the vertical signal lines VSL1 to VSL3 . . . in the low power consumption mode when the switches 181 to 183 . . . are turned off in the vertical blanking period.

In part a of FIG. 7, in the constant current mode, the consumption current in the readout period and the vertical blanking period is IPAmA.

In part b of FIG. 7, in the normal mode, the consumption current in the readout period is IPBmA, and the consumption current in the vertical blanking period is IPCmA. IPB=IPA+IPC. In the normal mode, although the current consumption in the readout period increases, the current consumption in the vertical blanking period decreases, as compared with the constant current mode. Here, the number of vertical signal lines VSL is larger than the number of dummy signal lines DSL. For this reason, although the increase in the consumption current in the readout period is slight, the decrease in the consumption current in the vertical blanking period is large. Therefore, in the normal mode, power consumption can be reduced as compared with the constant current mode.

In part c of FIG. 7, in the standby mode, the consumption current in the readout period is IPAmA, and the consumption current in the vertical blanking period is IPCmA. In the standby mode, although the consumption current in the readout period is equal to the consumption current in the constant current mode, the consumption current in the vertical blanking period decreases as compared with the constant current mode. Therefore, in the standby mode, power consumption can be reduced as compared with the normal mode.

In part d of FIG. 7, in the low power consumption mode, the current consumption in the readout period is IPAmAta, and the current consumption in the vertical blanking period is IPCmA. In the low power consumption mode, the current consumption slightly increases as compared with the current consumption in the constant current mode, and the current consumption in the vertical blanking period decreases as compared with the constant current mode. Therefore, in the low power consumption mode, power consumption can be reduced as compared with the constant current mode.

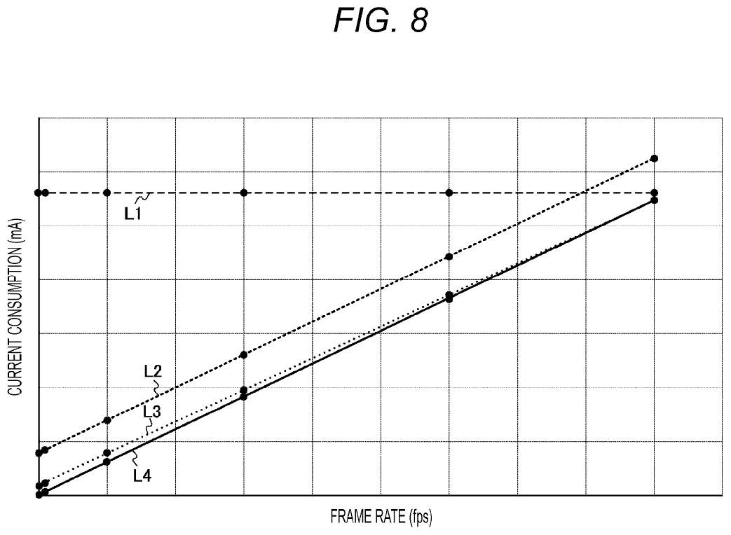

FIG. 8 is a diagram illustrating a relationship between a frame rate and current consumption in each mode of the solid-state imaging device according to the first embodiment. Note that L1 indicates the constant current mode, L2 indicates the normal mode, L3 indicates the low power consumption mode, and L4 indicates the standby mode.

In FIG. 8, the normal mode L2, the low power consumption mode L3, and the standby mode L4 have a large power consumption reduction effect at a low frame rate such as long-time exposure as compared with the constant current mode L1. However, in the normal mode L2, power consumption may increase at a high frame rate as compared with the constant current mode L1. Therefore, at a high frame rate with a fixed frame rate, the operation may be performed in the constant current mode L1.

Alternatively, the operation may be performed in the low power consumption mode L3 or the standby mode L4 in the readout period.

As described above, in the above-described first embodiment, the potential of the horizontal connection signal line HCL connecting the vertical signal lines VSL1 to VSL3 . . . is controlled on the basis of the potential of the dummy signal line DSL connected to the dummy pixel provided in the dummy column DCA. As a result, when the vertical signal lines VSL1 to VSL3 . . . are disconnected from the current sources 161 to 163 . . . , respectively, the dummy signal line DSL and the horizontal connection signal line HCL can be set to the same potential.

Therefore, it is possible to reduce the power consumption while suppressing the occurrence of the lateral streak caused by the coupling between each of the vertical signal lines VSL1 to VSL3 . . . and the pixel.

### 2. Second Embodiment

In the first embodiment described above, the potential of the horizontal connection signal line HCL is controlled on the basis of the potential of the dummy signal line DSL connected to the dummy pixel provided in the dummy column DCA. In a second embodiment, a plurality of dummy columns in which dummy pixels connected to dummy signal lines are arranged in the column direction is provided.

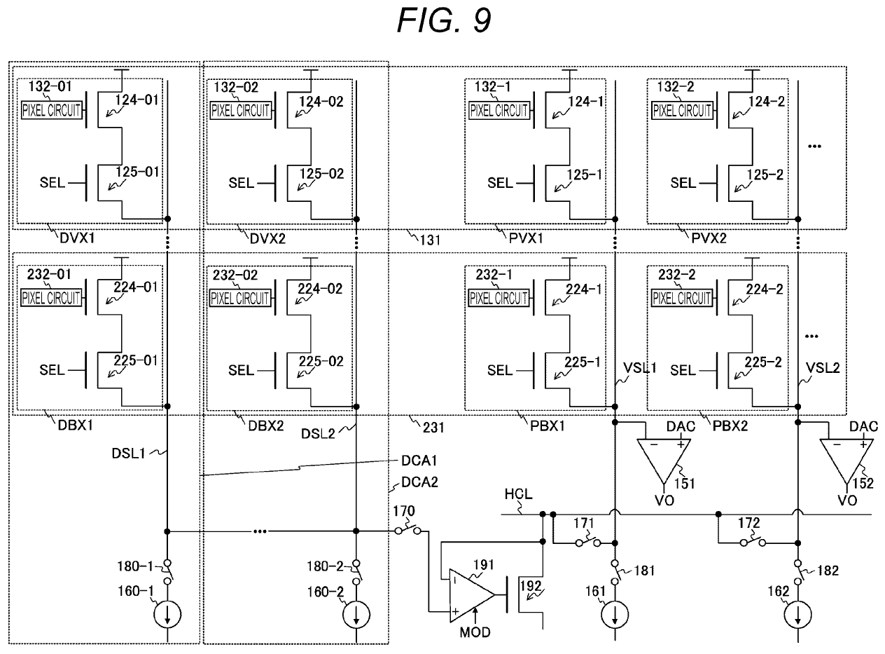

FIG. 9 is a diagram illustrating a configuration example of a light detection device according to the second embodiment.

In FIG. 9, an imaging device includes dummy columns DCA1 and DCA2 instead of the dummy column DCA of the first embodiment described above. Other configurations of the imaging device of the second embodiment are similar to the configurations of the imaging device of the first embodiment described above.

Each of the dummy columns DCA1 and DCA2 can be configured similarly to the dummy column DCA. At this time, a dummy effective pixel DVX1 and a dummy OPB pixel DBX1 are arranged in the dummy column DCA1. A dummy effective pixel DVX2 and a dummy OPB pixel DBX2 are arranged in the dummy column DCA2.

The dummy effective pixel DVX1 includes a pixel circuit 132-01, an amplification transistor 124-01, and a selection transistor 125-01. The dummy OPB pixel DBX1 includes a pixel circuit 232-01, an amplification transistor 224-01, and a selection transistor 225-01.

The dummy effective pixel DVX1 and the dummy OPB pixel DBX1 are connected to a dummy signal line DSL1. The dummy signal line DSL1 is connected to a current source 160-1 via a switch 180-1. In addition, the dummy signal line DSL1 is connected to an inverting input terminal of an operational amplifier 191 via a switch 170.

The dummy effective pixel DVX2 includes a pixel circuit 132-02, an amplification transistor 124-02, and a selection transistor 125-02. The dummy OPB pixel DBX2 includes a pixel circuit 232-02, an amplification transistor 224-02, and a selection transistor 225-02.

The dummy effective pixel DVX2 and the dummy OPB pixel DBX2 are connected to a dummy signal line DSL2. The dummy signal line DSL2 is connected to a current source 160-2 via a switch 180-2. In addition, the dummy signal line DSL2 is connected to the inverting input terminal of the operational amplifier 191 via the switch 170.

Each of the pixel circuits 132-01, 132-02, 232-01, and 232-02 can include a photodiode 121, a transfer transistor 122, a reset transistor 123, and a floating diffusion FD.

Here, the potentials of the plurality of dummy signal lines DSL1 and DSL2 are averaged and input to the non-inverting input of the operational amplifier 191. At this time, the operational amplifier 191 compares the average value of the potentials of the dummy signal lines DSL1 and DSL2 with the potential of a horizontal connection signal line HCL. Then, the operational amplifier 191 can drive a drive transistor 192 such that the average value of the potentials of the dummy signal lines DSL1 and DSL2 and the potential of the horizontal connection signal line HCL have the same potential.

As described above, in the above-described second embodiment, the plurality of dummy columns DCA1 and DCA2 in which the dummy pixels connected to the dummy signal lines DSL1 and DSL2 are arranged in the column direction is provided. As a result, the non-inverting input of the operational amplifier 191 can be set on the basis of the average value of the potentials of the plurality of dummy signal lines DSL1 and DSL2. Therefore, when the vertical signal lines VSL1 to VSL3 are disconnected from the current sources 161 to 163, respectively, the driving accuracy of the operational amplifier 191 for setting the dummy signal line DSL and the horizontal connection signal line HCL to the same potential can be improved.

Note that, in the second embodiment described above, the example in which the two dummy columns DCA1 and DCA2 are provided has been described, but three or more dummy columns may be provided.

### 3. Third Embodiment

In the first embodiment described above, the potential of the horizontal connection signal line HCL is controlled on the basis of the potential of the dummy signal line DSL connected to the dummy pixel provided in the dummy column DCA. In a third embodiment, n columns of dummy columns are provided in a part of m columns of ineffective pixel columns provided around the effective pixel array.

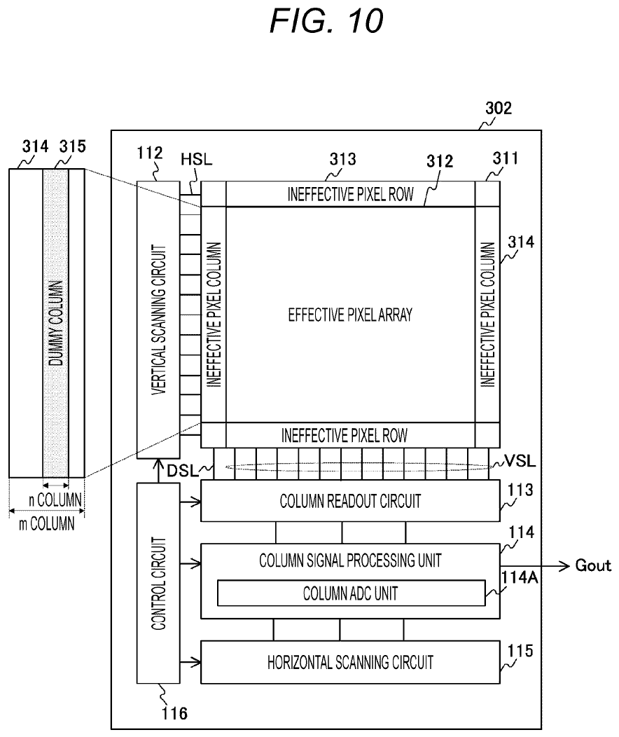

FIG. 10 is a block diagram illustrating a configuration example of a solid-state imaging device according to the third embodiment.

In FIG. 10, a solid-state imaging device 302 includes a pixel array unit 311 instead of the pixel array unit 111 of the first embodiment described above. Other configurations of the solid-state imaging device 302 of the third embodiment are similar to the configurations of the solid-state imaging device 102 of the first embodiment described above.

The pixel array unit 311 includes an effective pixel array 312, an ineffective pixel row 313, and an ineffective pixel column 314. The ineffective pixel rows 313 may be arranged on both sides of the effective pixel array 312 in the column direction. The ineffective pixel columns 314 may be arranged on both sides of the effective pixel array 312 in the row direction.

In the effective pixel array 312, effective pixels are arranged in a matrix along the row direction and the column direction. In the ineffective pixel row 313, ineffective pixels are arranged along the row direction. In the ineffective pixel column 314, ineffective pixels are arranged along the column direction. There can be provided m columns of ineffective pixel columns 314. At this time, n columns of dummy columns 315 can be provided in the ineffective pixel column 314. In the dummy column 315, dummy pixels are arranged in the column direction.

A dummy effective pixel and a dummy OPB pixel can be provided in the dummy pixel. The dummy column 315 is connected to a dummy signal line DSL. The configuration of one column of the dummy column 315 can be configured similarly to the dummy column DCA of the first embodiment described above.

As described above, in the above-described third embodiment, the dummy column 315 is provided in a part of the ineffective pixel column 314 provided around the effective pixel array 312. As a result, n columns of dummy pixels can be arranged around the effective pixel array 312.

### 4. Fourth Embodiment

In the first embodiment described above, the pixel in which electrons are accumulated on the basis of photoelectric conversion is applied to the solid-state imaging device. In a fourth embodiment, a pixel in which holes are accumulated on the basis of photoelectric conversion is applied to a solid-state imaging device.

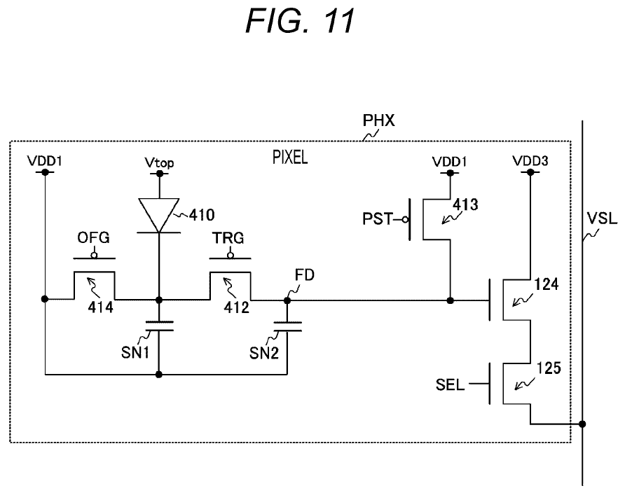

FIG. 11 is a diagram illustrating a circuit configuration example of a pixel provided in the solid-state imaging device according to the fourth embodiment.

In FIG. 11, a pixel PHX includes a photodiode 410, a transfer transistor 412, and a reset transistor 413 instead of the photodiode 121, the transfer transistor 122, and the reset transistor 123 of the pixel PIX of the first embodiment described above. In addition, in the pixel PHX, capacitors SN1 and SN2 and a discharge transistor 414 are added to the pixel PIX of the first embodiment described above. An N-channel field effect transistor can be used as an amplification transistor 124 and a selection transistor 125. A P-channel field effect transistor can be used as the transfer transistor 412, the reset transistor 413, and the discharge transistor 414. The capacitors SN1 and SN2 may be metal insulation metal (MIM) capacitors or junction capacitors formed on a semiconductor substrate.

The photodiode 410 generates holes on the basis of photoelectric conversion. As a material of the photodiode 410, for example, a compound semiconductor of an InGaP, InAlP, InGaAs, InAlAs, or chalcopyrite structure can be used. At this time, the photodiode 410 can have sensitivity to infrared region light (for example, a wavelength band of a wavelength of 900 nm to 1700 nm). A power supply voltage Vtop is applied to an anode of the photodiode 410. The power supply voltage Vtop is variable according to a reset voltage for initializing the charge of the photodiode 410.

The transfer transistor 412 transfers the charge accumulated in the photodiode 410 to a floating diffusion FD. The reset transistor 413 resets the charge accumulated in the floating diffusion FD. The discharge transistor 414 discharges the charge accumulated in the capacitor SN1.

The amplification transistor 124 and the selection transistor 125 are connected in series. A series circuit of the amplification transistor 124 and the selection transistor 125 is connected between a power supply voltage VDD3 and a vertical signal line VSL. A cathode of the photodiode 410 is connected to the floating diffusion FD via the transfer transistor 412. In addition, the floating diffusion FD is connected to a power supply voltage VDD1 via the reset transistor 123. The voltage VDD1 is lower than the power supply voltage Vtop.

The capacitor SN1 is connected to the anode of the photodiode 410. The transfer transistor 412 and the discharge transistor 414 are connected in series. A series circuit of the transfer transistor 412 and the discharge transistor 414 is connected between the power supply voltage VDD1 and the floating diffusion FD. The capacitor SN2 is connected to the floating diffusion FD.

A transfer signal TGL is applied to a gate of the transfer transistor 412. A reset signal PST is applied to a gate of the reset transistor 413. A discharge signal OFG is applied to a gate of the discharge transistor 414.

As described above, in the above-described fourth embodiment, the pixel PHX in which holes are accumulated on the basis of photoelectric conversion is applied to the solid-state imaging device. As a result, it is possible to reduce the power consumption while suppressing the occurrence of lateral streak caused by the coupling between the vertical signal line VSL and the pixel PHX, and the sensitivity to the infrared region can be improved.

### 5. Fifth Embodiment

In the first embodiment described above, the potential of the horizontal connection signal line HCL connecting the vertical signal lines VSL1 to VSL3 . . . is controlled on the basis of the potential of the dummy signal line DSL connected to the dummy pixel provided in the dummy column DCA. In a fifth embodiment, semiconductor chips on which a solid-state imaging device provided with a pixel array unit in which pixels are arranged in a matrix is formed, are laminated.

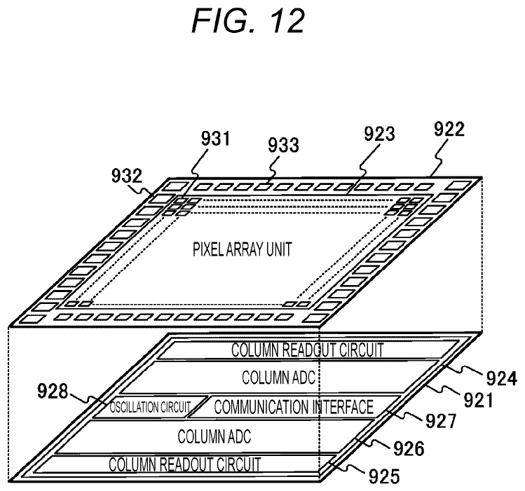

FIG. 12 is a perspective view illustrating a lamination example of the solid-state imaging device according to the fifth embodiment.

In FIG. 12, the solid-state imaging device includes semiconductor chips 921 and 922. The semiconductor chip 922 is laminated on the semiconductor chip 921.

A pixel array unit 923 is formed on the semiconductor chip 922. The pixel array unit 923 includes pixels 931 arranged in a matrix in the row direction and the column direction. The pixel 931 may be the pixel PIX in FIG. 3 or the pixel PHX in FIG. 11. Pad electrodes 932 and via electrodes 933 are formed around the pixel array unit 923. The via electrode 933 penetrates the semiconductor chip 922 and can electrically connect the semiconductor chips 921 and 922 to each other.

A peripheral circuit 924 is formed on the semiconductor chip 921. In the peripheral circuit 924, a column readout circuit 925, a column ADC 926, a communication interface 927, and an oscillation circuit 928 are formed. The column readout circuit 925 and the column ADC 926 may be formed in such a way as to correspond to positions on both sides of the pixel array unit 923 in the column direction.

The semiconductor chips 921 and 922 may be directly bonded. For the direct bonding of the semiconductor chips 921 and 922, hybrid bonding can be used. At this time, the semiconductor chips 921 and 922 may be electrically connected based on Cu—Cu connection. A material of the semiconductor substrate used for the semiconductor chips 921 and 922 may be Si, InGaAs, or InP.

As described above, in the above-described fifth embodiment, the semiconductor chip 922 on which the pixel array unit 923 is formed is laminated on the semiconductor chip 921 on which the peripheral circuit 924 is formed. This makes it possible to increase sensitivity of the solid-state imaging device while suppressing an increase in mounting area of the semiconductor chip on which the solid-state imaging device is formed.

Note that, the above-described embodiments indicate examples for embodying the present technology, and the respective matters in the embodiments and the respective matters specifying the invention in the claims have correspondence relationships. Similarly, the respective matters specifying the invention in the claims and the respective matters with the same names in the embodiments of the present technology have correspondence relationships. The present technology, however, is not limited to the embodiments, and can be implemented by modifying the embodiments in various ways without departing from the scope thereof. Furthermore, the effects described in the present specification are merely examples and not restrictive, and other effects may also be produced.

Note that the present technology can also have the following configurations.
(1) A light detection device including:
a first signal line connected to a first effective pixel;
a first current source connected to the first signal line;
a first switch provided between the first effective pixel and the first current source;
a second signal line connected to a second effective pixel;
a second current source connected to the second signal line;
a second switch provided between the second effective pixel and the second current source;
a horizontal connection signal line that connects the first signal line and the second signal line;
a dummy signal line connected to a dummy pixel; a third current source connected to the dummy signal line; and
a control unit that controls a potential of the horizontal connection signal line on the basis of a potential of the dummy signal line.
(2) The light detection device according to (1), in which
the control unit performs control such that the dummy signal line and the horizontal connection signal line have the same potential.
(3) The light detection device according to (1) or (2), in which
the control unit includes an operational amplifier in which a first input is connected to the dummy signal line and a second input is connected to the horizontal connection signal line.
(4) The light detection device according to (3), in which
the control unit includes a transistor that drives the horizontal connection signal line on the basis of an output of the operational amplifier.
(5) The light detection device according to (4), in which
the control unit includes a mode setting unit that sets a current flowing through the transistor in a readout period.
(6) The light detection device according to any one of (1) to (5), in which
the dummy pixel includes an optical black (OPB) pixel.
(7) The light detection device according to any one of (1) to (6), further including:
a third switch provided between the first signal line and the horizontal connection signal line; and
a fourth switch provided between the second signal line and the horizontal connection signal line.
(8) The light detection device according to (7), in which
the first switch and the second switch are turned off in a vertical blanking period, and
the third switch and the fourth switch are turned on in the vertical blanking period.
(9) The light detection device according to (7) or (8), in which
the first switch and the second switch are turned off in a horizontal blanking period, and
the third switch and the fourth switch are turned on in the horizontal blanking period.
(10) The light detection device according to claim 1, further including
a fifth switch provided between the dummy pixel and the third current source.
(11) The light detection device according to any one of (1) to (10), in which
the fifth switch is turned on in a vertical blanking period and turned off in a readout period.
(12) The light detection device according to (11), in which
the fifth switch is turned on in a horizontal blanking period and turned off in a readout period.
(13) The light detection device according to any one of (1) to (12), further including:
a first column in which the first effective pixels are arranged in a column direction;
a second column in which the second effective pixels are arranged in the column direction; and
a dummy column in which the dummy pixels are arranged in the column direction.
(14) The light detection device according to (13), in which
the first column includes the first effective pixel and a first OPB pixel,
the second column includes the second effective pixel and a second OPB pixel, and
the dummy column includes a dummy effective pixel and a dummy OPB pixel.
(15) The light detection device according to (13) or (14), in which
a plurality of the dummy columns is provided.

### REFERENCE SIGNS LIST

100 Imaging device
101 Optical system
102 Solid-state imaging device
103 Imaging control unit
104 Image processing unit
105 Storage unit
106 Display unit
107 Operation unit
108 Bus
111 Pixel array unit
112 Vertical scanning circuit
113 Column readout circuit
114 Column signal processing unit
115 Horizontal scanning circuit
116 Control circuit
121 Photodiode
122 Transfer transistor
123 Reset transistor
124 Amplifier transistor
125 Selection transistor
PIX Pixel
DIX Dummy pixel
HSL Horizontal drive line
VSL Vertical signal line
HCL Horizontal connection signal line
DSL Dummy signal line
DCA Dummy column
132-0 to 132-3, 232-0 to 232-3 Pixel circuit
151 to 153 Comparator
161 to 163 Current source
170 to 173, 180 to 183 Switch
191 Operational amplifier
192 Drive transistor
131 Effective pixel region
231 OPB pixel region
DVX Dummy effective pixel
DBX Dummy OPB pixel
PVX Effective pixel
PBX OPB pixel

1. A light detection device comprising:
a first signal line connected to a first effective pixel;
a first current source connected to the first signal line;
a first switch provided between the first effective pixel and the first current source;
a second signal line connected to a second effective pixel;
a second current source connected to the second signal line;
a second switch provided between the second effective pixel and the second current source;
a horizontal connection signal line that connects the first signal line and the second signal line;
a dummy signal line connected to a dummy pixel;
a third current source connected to the dummy signal line; and
a control unit that controls a potential of the horizontal connection signal line on a basis of a potential of the dummy signal line.

2. The light detection device according to claim 1, wherein
the control unit performs control such that the dummy signal line and the horizontal connection signal line have a same potential.

3. The light detection device according to claim 1, wherein
the control unit includes an operational amplifier in which a first input is connected to the dummy signal line and a second input is connected to the horizontal connection signal line.

4. The light detection device according to claim 3, wherein
the control unit includes a transistor that drives the horizontal connection signal line on a basis of an output of the operational amplifier.

5. The light detection device according to claim 4, wherein
the control unit includes a mode setting unit that sets a current flowing through the transistor in a readout period.

6. The light detection device according to claim 1, wherein
the dummy pixel includes an optical black (OPB) pixel.

7. The light detection device according to claim 1, further comprising:
a third switch provided between the first signal line and the horizontal connection signal line; and
a fourth switch provided between the second signal line and the horizontal connection signal line.

8. The light detection device according to claim 7, wherein
the first switch and the second switch are turned off in a vertical blanking period, and
the third switch and the fourth switch are turned on in the vertical blanking period.

9. The light detection device according to claim 7, wherein
the first switch and the second switch are turned off in a horizontal blanking period, and
the third switch and the fourth switch are turned on in the horizontal blanking period.

10. The light detection device according to claim 1, further comprising
a fifth switch provided between the dummy pixel and the third current source.

11. The light detection device according to claim 10, wherein
the fifth switch is turned on in a vertical blanking period and turned off in a readout period.

12. The light detection device according to claim 10, wherein
the fifth switch is turned on in a horizontal blanking period and turned off in a readout period.

13. The light detection device according to claim 1, further comprising:
a first column in which the first effective pixels are arranged in a column direction;
a second column in which the second effective pixels are arranged in the column direction; and
a dummy column in which the dummy pixels are arranged in the column direction.

14. The light detection device according to claim 13, wherein
the first column includes the first effective pixel and a first OPB pixel,
the second column includes the second effective pixel and a second OPB pixel, and
the dummy column includes a dummy effective pixel and a dummy OPB pixel.

15. The light detection device according to claim 13, wherein
a plurality of the dummy columns is provided.
